(19) United States
(12) Patent Application Publication
(10) Pub. No.: US 2026/0298746 A1
(43) Pub. Date: Oct. 1, 2026

(54) PRESSURE SENSOR AND PROCESS FOR MANUFACTURING SAME

(71) Applicant: SC2N, Mondeville (FR)

(72) Inventors: Albin LE SERGENT, Cergy (FR); Fabien LEMOIGNE, Cergy (FR)

(73) Assignee: SC2N, Mondeville (FR)

(21) Appl. No.: 19/489,026

(22) PCT Filed: May 16, 2024
(86) PCT No.: PCT/EP2024/063630

§ 371 Date: Dec. 1, 2025

(30) Foreign Application Priority Data
May 31, 2023 (FR) FR2305457

(51) Int. Cl. G01L 9/00; G01L 19/00; G01L 19/14

(52) U.S. Cl. CPC G01L 9/0055; G01L 19/0069; G01L 19/148

(57) ABSTRACT

The invention relates to a pressure sensor comprising a connector, a printed circuit (3), a metallic body and a pressure-sensitive element (5) comprising a substrate (6) comprising an internal face connected to the metallic body (4) and an external face (7) covered by a dielectric layer (8) on which there are positioned four resistors (9, 10, 11, 12) arranged to form four electrical poles (13, 14, 15, 16), each electrical pole being formed between two resistors and being connected to a conducting zone (17, 18, 19, 20) extending on the dielectric layer, each conducting zone being electrically connected to a connecting zone (21, 22, 23, 24) formed on the printed circuit by a connecting element (25, 26, 27, 28). The external face of the substrate comprises at least one earthing zone (30, 31) electrically connected to the printed circuit by a connecting means (32, 33).

### TECHNICAL FIELD

The invention relates to the field of pressure sensors. It relates more particularly to the field of pressure sensors for motor vehicle cooling or air conditioning systems and to a method for the manufacture of such a sensor.

### BACKGROUND OF THE INVENTION

Pressure sensors are commonly used in motor vehicles to measure the pressure of fluids such as gases, liquids or a gas/liquid mixture in an air-conditioning system intended to regulate the temperature in the vehicle interior or inside a cooling system for cooling an electric motor or a heat engine, for example.

The pressure sensor traditionally comprises a metallic body, a plastic connector and a pressure-sensitive element comprising a substrate secured to the metallic body. The substrate forms a membrane that is deformable under the effect of the pressure.

In order to manufacture the pressure sensor, a first dielectric layer is deposited over the entirety of an upper face of the substrate.

Four resistors are then printed and etched on the first dielectric layer and are interconnected in series to form a loop known as a Wheatstone bridge. This Wheatstone bridge forms, between each adjacent resistor, four poles each having its own individual electrical potential.

Four connecting zones commonly referred to as pads are then printed on the four poles so that the four electrical potentials of the four poles can be accessed.

The pressure sensor also comprises an electronic board carrying at least a signal processing unit. Four connection zones are also printed on the electronic board close to the substrate and are electrically connected to the signal processing unit.

An electrical connection is made between the connecting zones of the electronic board and the connecting zones of the substrate.

A pressure applied to the lower face of the membrane causes the membrane and the four resistors to deform, thus causing the resistance of the resistors to vary.

The variations in the resistance of the resistors cause the Wheatstone bridge to become unbalanced. A voltage, which is a reflection of the pressure due to the imbalance of the Wheatstone bridge, is measured via the connecting zones and processed by the signal processing unit.

The substrate is formed of a metal alloy. The substrate is welded to the metallic body. The interface between the substrate and the metallic body is fluidtight and electrical continuity between the two components is assured.

In order to provide the pressure sensor with immunity to magnetic fields, it is necessary to add a conducting element having a certain elasticity between the electronic board and the metallic body in order to provide electrical contact (or coupling) between the electrical earth of the pressure sensor and the metallic body.

The conducting element is a shaped thin sheet of metal or else a metallic spring.

However, this solution of the prior art presents a problem of bulk and of cost because it is necessary to add an additional conducting element during an additional step, lengthening the manufacturing time and rendering the manufacturing process more complex.

### SUMMARY OF THE INVENTION

It is an object of the invention therefore to alleviate the disadvantages of the prior art by proposing a method for the manufacture of a pressure sensor that is simpler and faster and able to yield a pressure sensor that is simplified, because it comprises fewer components, and less expensive.

In order to do so, the invention thus, in its broadest sense, relates to a pressure sensor comprising a connector, a printed circuit, a metallic body and a pressure-sensitive element comprising a substrate comprising an internal face connected to the metallic body and an external face covered with a dielectric layer on which there are positioned four resistors arranged to form four electrical poles. Each electrical pole is formed between two resistors and it is connected to a conducting zone extending on the dielectric layer. Each conducting zone is electrically connected to a connecting zone formed on the printed circuit by a connecting element.

According to the invention, the external face of the substrate comprises at least one earthing zone electrically connected to the printed circuit by a connecting means.

The invention thus provides a pressure sensor that is simplified, because it comprises fewer components, and less expensive. There is no longer any need to add a conducting element exhibiting a certain elasticity between the electronic board and the metallic body.

In a variant, the earthing zone is positioned between two conducting zones.

This configuration enables the dimension of the pressure-sensitive element not to be increased.

According to another variant, each connecting means is a jumper wire having a first end connected to the earthing zone and a second end connected to a connecting zone formed on the printed circuit.

This solution provides a solution that simplifies the manufacturing process.

According to another variant, the earthing zone is formed by a spared portion of the external face of the substrate. The spared portion is directly connected to the printed circuit.

This solution makes it possible to reduce the manufacturing steps.

According to another variant, the earthing zone is formed by a portion of a first metallic layer covering a spared portion of the external face of the substrate. The four resistors are formed by other portions of the first metallic layer. The first metallic layer portion is connected to the printed circuit.

According to another variant, the earthing zone is formed by a metallic conducting zone covering a first metallic layer portion, the first metallic layer portion itself covering a spared portion of the external face of the substrate. The metallic conducting zone is connected to the printed circuit.

This solution makes it possible to use the same steps as those performed for forming the conducting zones, thereby simplifying the manufacturing process.

The invention also relates to an air conditioning system for a motor vehicle, comprising a pressure sensor as defined hereinabove.

The invention also relates to a method for the manufacture of a pressure sensor, comprising:
a step of depositing a dielectric layer on an external face of the substrate,
a step of depositing a first metallic layer on the dielectric layer,
a step of depositing a second metallic layer on the first metallic layer,
a step of etching the first metallic layer to form four resistors on the dielectric layer, these resistors being arranged to form four electrical poles, a conducting zone being formed on a portion of each electrical pole starting from the second metallic layer, and
a step of connecting the conducting zone and a connecting zone formed on the printed circuit, using a connecting element.

According to the invention, the manufacturing process comprises an operation of earthing the pressure-sensitive element, comprising a step of forming at least one earthing zone on the external face of the substrate and a step of electrically connecting the earthing zone and the printed circuit using a connecting means.

The invention thus provides a method for the manufacture of a pressure sensor that is simpler and faster because it comprises one fewer step compared with the known solutions that consist in mounting a resilient conducting element between the metallic body and the electronic board.

According to one variant, during the step of depositing the dielectric layer on the external face of the substrate, at least one spared portion is formed on the external face of the substrate by masking off a portion of the external face during the depositing of the dielectric layer.

The earthing zone is produced at the same time as the depositing of the dielectric layer, without an additional step, thereby simplifying the manufacturing method.

According to another variant, the external face of the substrate is completely covered by the dielectric layer during the step of depositing the dielectric layer on the external face of the substrate. A laser-ablation operation is then applied to at least a portion of the dielectric layer in order to form at least one spared portion on the external face of the substrate.

According to another variant, the spared portion forms the earthing zone. The method comprises an electrical-connection step during which the connecting means connects the spared portion to a connecting zone formed on the printed circuit.

This electrical connection is performed at the same time as the connection between the conducting zone and the connecting zone of the printed circuit.

According to another variant, the first metallic layer covers the spared portion during the step of depositing the first metallic layer. The earthing zone is then formed by a portion of the first metallic layer covering the spared portion and at the same time as the conducting zones.

The earthing zone is produced at the same time as the resistors, without additional steps.

According to another variant, a portion of the first metallic layer covers the spared portion during the step of depositing the first metallic layer. A second metallic layer is deposited on that portion of the first metallic layer that covers the spared portion so as to form a metallic conducting zone. The metallic conducting zone then forms the earthing zone.

The earthing zone is produced at the same time as the conducting zones of the pressure-sensitive element, simplifying and reducing the duration of the manufacturing method.

### BRIEF DESCRIPTION OF THE DRAWINGS

Forms of embodiment of the present invention will be described hereinafter by way of nonlimiting examples with reference to the attached figures in which:

FIG. 1 schematically illustrates a pressure sensor according to one embodiment of the invention;

FIG. 2 schematically illustrates a pressure-sensitive element connected to a printed circuit of the pressure sensor of FIG. 1;

FIG. 3 schematically illustrates a pressure-sensitive element according to another embodiment of the invention;

FIG. 4 schematically illustrates a pressure-sensitive element according to another embodiment of the invention.

### DETAILED DESCRIPTION OF THE INVENTION

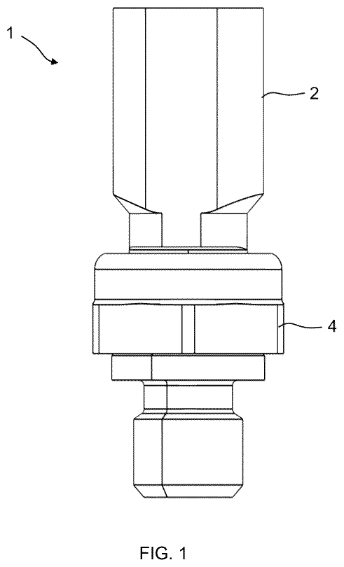

The invention relates to a pressure sensor 1 as illustrated in FIG. 1, and to a method for the manufacture thereof.

This pressure sensor 1 may be used in motor vehicles to measure the pressure of fluids such as gases, liquids or a gas/liquid mixture in an air-conditioning system intended to regulate the temperature in the vehicle interior or inside a cooling system for cooling an electric motor or a heat engine, for example.

The pressure sensor 1 comprises a metallic body 4 and a connector 2 comprising a protective casing made of plastic and connected to the metallic body 4.

The pressure sensor 1 comprises a pressure-sensitive element 5 comprising a substrate 6 secured to the metallic body 4. The substrate 6 forms a membrane that is deformable under the effect of the pressure. The substrate 6 is formed from a metal alloy and comprises an internal face connected to the metallic body 4, and an external face 7.

The substrate 6 is welded to the metallic body 4. The interface between the substrate 6 and the metallic body 4 is fluidtight and electrical continuity between the two components is assured.

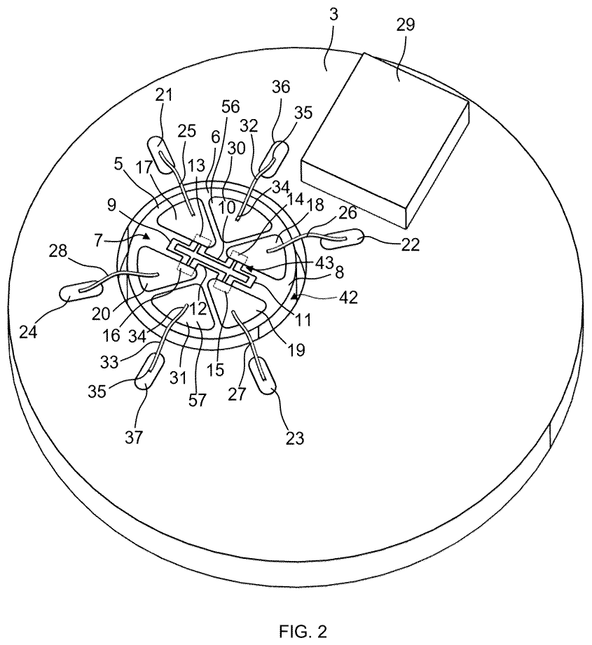

The pressure sensor 1 comprises a printed circuit 3 (or electronic board). The pressure-sensitive element 5 is housed in a circular orifice 42 provided in the printed circuit 3, as illustrated in FIG. 2.

The method for manufacturing the pressure sensor 1 comprises a step of depositing a dielectric layer 8 on the external face 7 of the substrate 6. The dielectric layer 8 is formed of a silicon oxide, for example.

The manufacturing method next comprises a step of depositing a first metallic layer on the dielectric layer 8. The first metallic layer is more specifically printed onto the dielectric layer 8. The first metallic layer is formed of a nickel/chrome alloy, for example.

Four resistors 9, 10, 11, 12 are etched starting from the first metallic layer and interconnected in series to form a loop known as a Wheatstone bridge 43. This Wheatstone bridge 43 forms, between each adjacent resistor 9, 10, 11, 12, four poles 13, 14, 15, 16 each having its own individual electrical potential. Each electrical pole 13, 14, 15, 16 is formed between two resistors 9, 10, 11, 12.

The manufacturing method comprises a step of depositing a second metallic layer on the first metallic layer and the dielectric layer 8 to form a conducting zone 17, 18, 19, 20 on a portion of each electrical pole 13, 14, 15, 16.

The four conducting zones 17, 18, 19, 20 are commonly referred to as pads and they extend on the dielectric layer 8. Each conducting zone 17, 18, 19, 20 has the overall shape of a triangle, for example. Other shapes are possible.

The four conducting zones 17, 18, 19, 20 enable the four electrical potentials of the four poles 13, 14, 15, 16 to be accessed. The four conducting zones 17, 18, 19, 20 are formed of a nickel/gold alloy, for example.

As a preference, the Wheatstone bridge 43 and the four conducting zones 17, 18, 19, 20 are obtained by using the well-known printing method known as the “thin-film” technique.

The manufacturing method next comprises a step of connecting the conducting zone 17, 18, 19, 20 and a connecting zone 21, 22, 23, 24 formed on the printed circuit 3, using a connecting element 25, 26, 27, 28.

Four connecting zones 21, 22, 23, 24 are formed on the printed circuit 3 close to and around the substrate 6.

Four connecting elements 25, 26, 27, 28 are thus formed for electrically connecting the four conducting zones 17, 18, 19, 20 of the pressure-sensitive element 5 to the four respective connecting zones 21, 22, 23, 24 of the printed circuit 3.

This connection is made by using the bridging technology also known as “wire bonding”.

The four connecting elements 25, 26, 27, 28 are, in this example, conducting wires.

As a variant, each conducting zone 17, 18, 19, 20 is connected to each connecting zone 21, 22, 23, 24 by a flexible circuit (not depicted).

The printed circuit 3 comprises a signal processing unit 29. The four connecting zones 21, 22, 23, 24 of the printed circuit 3 are electrically connected to the signal processing unit 29.

Thus, a pressure applied to the internal face of the pressure-sensitive element 5 (or membrane) causes deformation of the pressure-sensitive element 5 and of the four resistors 9, 10, 11, 12 and therefore causes the resistance of the resistors 9, 10, 11, 12 to vary.

The variations in the resistance of the resistors 9, 10, 11, 12 cause the Wheatstone bridge 43 to become unbalanced. A voltage, which is a reflection of the pressure due to the imbalance of the Wheatstone bridge 43, is measured via the connecting zones 21, 22, 23, 24 and processed by the signal processing unit 29.

According to the invention, the method for the manufacture of the pressure sensor 1 comprises an operation of earthing the pressure-sensitive element 5, comprising a step of forming at least one earthing zone 30, 31 on the external face 7 of the substrate 6.

The external face 7 of the substrate 6 therefore comprises at least one earthing zone 30, 31 electrically connected to the printed circuit 3 by a connecting means 32, 33 so as to ensure that the pressure sensor 1, and more specifically the pressure-sensitive element 5, is immune to magnetic fields.

In the example of FIG. 2, the pressure-sensitive element 5 comprises two earthing zones 30, 31 each positioned between two conducting zones 17, 18, 19, 20.

A first earthing zone 30 is positioned between a first conducting zone 17 and a second conducting zone 18. A second earthing zone 31 is positioned between a third conducting zone 19 and a fourth conducting zone 20.

As a variant, the pressure-sensitive element 5 may comprise a single earthing zone 30, 31.

The two earthing zones 30, 31 have the overall shape of a triangle the same shape and approximately the same size as the four conducting zones 17, 18, 19, 20 of the pressure-sensitive element 5. The two earthing zones 30, 31 are positioned one facing the other.

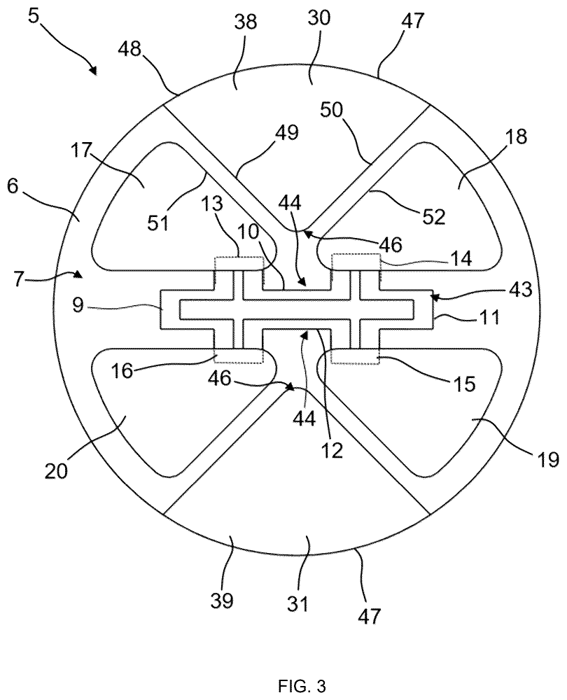

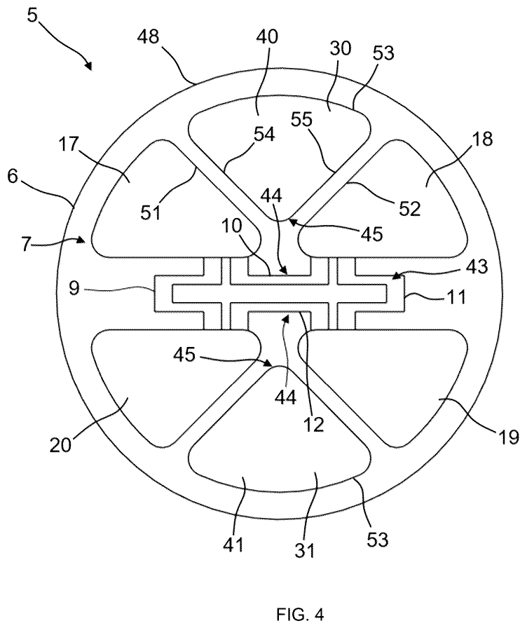

The Wheatstone bridge 43 has an elongate overall shape with two opposite longitudinal sides 44, as illustrated in FIG. 3 and FIG. 4. Each earthing zone 30, 31 has a vertex 45 positioned facing one of the two longitudinal sides 44.

According to an embodiment depicted in FIG. 3, during the step of depositing the dielectric layer 8 on the external face 7 of the substrate 6, a first spared portion 38 and a second spared portion 39 are formed on the external face 7 of the substrate 6. The spared portions 38, 39 may be obtained by masking off two portions of the external face 7 during the depositing of the dielectric layer 8. The spared portions 38, 39 are in fact zones on the external face 7 of the substrate 6 that are not covered by the dielectric layer 8.

Each spared portion 38, 39 has a triangular overall shape with a main vertex 46 positioned facing one of the two longitudinal sides 44 of the Wheatstone bridge 43.

The spared portions 38, 39 may be produced using a physical mask or else by photolithography. The spared portions 38, 39 are produced during the printing of the dielectric layer 8.

The spared portions 38, 39 are positioned one facing the other and are separated by the Wheatstone bridge 43.

Each spared portion 38, 39 extends from the main vertex 46 as far as an opposite side 47 flush with a peripheral border 48 of the substrate 6. The spared portion 38, 39 comprises a first edge 49 and a second edge 50 which are rectilinear. The first edge 49 runs along a first side 51 of the first conducting zone 17. The second edge 50 runs along a second side 52 of the second conducting zone 18.

The first spared portion 38 forms a first earthing zone 30 and the second spared portion 39 forms a second earthing zone 31.

The operation of earthing the pressure-sensitive element 5 next comprises a step of electrically connecting the earthing zones 30, 31 and the printed circuit 3 using a connecting means (not depicted in this example).

Each connecting means has a first end connected to one of the spared portions 38, 39, and a second end connected to a connecting zone 36, 37 formed on the printed circuit 3.

According to another embodiment depicted in FIG. 4, the external face 7 of the substrate 6 is completely covered by the dielectric layer 8 during the step of depositing the dielectric layer 8 on the external surface 7 of the substrate 6. This depositing is followed by a laser ablation operation applied to at least a portion of the dielectric layer 8 so as to form at least one spared portion 40, 41.

In the example of FIG. 4, the laser ablation operation is applied to a first portion of the dielectric layer 8 to form a first spared portion 40 and to a second portion of the dielectric layer 8 to form a second spared portion 41.

Each spared portion 40, 41 has a triangular overall shape with one vertex 45 positioned facing one of the two longitudinal sides 44 of the Wheatstone bridge 43.

The spared portions 40, 41 are positioned one facing the other and are separated by the Wheatstone bridge 43.

Each spared portion 40, 41 extends from the vertex 45 as far as an opposite side 53 running along a peripheral border portion 48 of the substrate 6.

The spared portion 40, 41 comprises a first edge 54 and a second edge 55 which are rectilinear. The first edge 54 runs along a first side 51 of the first conducting zone 17. The second edge 55 runs along a second side 52 of the second conducting zone 18.

The first spared portion 40 forms a first earthing zone 30 and the second spared portion 41 forms a second earthing zone 31.

The operation of earthing the pressure-sensitive element 5 next comprises a step of electrically connecting the two spared portions 40, 41 and the printed circuit 3 using a connecting means (not depicted in this example).

Each connecting means has a first end connected to one of the spared portions 40, 41, and a second end connected to a connecting zone 36, 37 formed on the dielectric layer 8 of the printed circuit 3.

According to another embodiment (not depicted), the first metallic layer covers the two spared portions 38, 39, 40, 41 during the step of depositing the first metallic layer to form two earthing zones 30, 31.

The two earthing zones 30, 31 are formed by a portion of the first metallic layer covering the spared portion 38, 39, 40, 41 and at the same time as the four conducting zones 17, 18, 19, 20.

As a variant, a single spared portion 38, 39, 40, 41 may be formed regardless of the method used: either masking according to the embodiment of FIG. 3, or ablation according to the embodiment of FIG. 4. A single first metallic layer portion may also be produced so as to form a single earthing zone 30, 31.

The operation of earthing the pressure-sensitive element 5 next comprises a step of electrically connecting the two first metallic layer portions and the printed circuit 3 using two connecting means (not depicted in this example).

Each connecting means has a first end connected to one of the first metallic layer portions, and a second end connected to a connecting zone 36, 37 formed on the dielectric layer 8 of the printed circuit 3.

According to another embodiment illustrated in FIG. 2, the first metallic layer covers the two spared portions 38, 39, 40, 41 during the step of depositing the first metallic layer. An etching step is performed to form the two portions of the first metallic layer covering the two spared portions 38, 39, 40, 41.

A second metallic layer is then deposited on the two portions of the first metallic layer. The second metallic layer enables the creation of two metallic conducting zones 56, 57 that are superposed on the two respective portions of the first metallic layer, using etching, for example. A first metallic conducting zone 56 forms a first earthing zone 30. A second metallic conducting zone 57 forms a second earthing zone 31.

The two metallic conducting zones 56, 57 are made of nickel/gold alloy and are printed at the same time as the conducting zones 17, 18, 19, 20 that are connected to the Wheatstone bridge 43.

The operation of earthing the pressure-sensitive element 5 next comprises a step of electrically connecting the first metallic conducting zone 56 and the printed circuit 3 using a first connecting means 32, and the second metallic conducting zone 57 and the printed circuit 3 using a second connecting means 33.

Each connecting means 32, 33 has a first end 34 connected to one of the metallic conducting zones 56, 57 and a second end 35 connected to one of the two connecting zones 36, 37 formed on the dielectric layer 8 of the printed circuit 3.

In the example of FIG. 2, the connecting means 32, 33 are conducting wires 32, 33. The connection is made by using the bridging technology also known as “wire bonding”. The conducting wires 32, 33 may be made of aluminum or of gold.

As a variant, the connecting means 32, 33 may be flexible circuits (not depicted).

As a variant, the pressure-sensitive element 5 may comprise a single earthing zone 30.

As a variant, the pressure-sensitive element 5 may comprise more than two earthing zones 30, 31.

What is claimed is:

1. A pressure sensor comprising a connector, a printed circuit, a metallic body and a pressure-sensitive element including a substrate including an internal face connected to the metallic body and an external face covered by a dielectric layer on which there are positioned four resistors arranged to form four electrical poles, each electrical pole being formed between two resistors and being connected to a conducting zone extending on the dielectric layer, each conducting zone being electrically connected to a connecting zone formed on the printed circuit by a connecting element wherein the external face of the substrate includes at least one earthing zone electrically connected to the printed circuit by a connecting means.

2. The pressure sensor according to claim 1, wherein the earthing zone is positioned between two conducting zones.

3. The pressure sensor according to claim 1, wherein each connecting means is a jumper wire having a first end connected to the earthing zone and a second end connected to a connecting zone formed on the printed circuit.

4. The pressure sensor according to claim 1, wherein the earthing zone is formed by a spared portion of the external face of the substrate, the spared portion being directly connected to the printed circuit.

5. The pressure sensor according to claim 1, wherein the earthing zone is formed by a portion of a first metallic layer covering a spared portion of the external face of the substrate, the four resistors being formed by other portions of the first metallic layer, the first metallic layer portion being connected to the printed circuit.

6. The pressure sensor according to claim 1, wherein the earthing zone is formed by a metallic conducting zone covering a first metallic layer portion, the first metallic layer portion covering a spared portion of the external face of the substrate, the metallic conducting zone being connected to the printed circuit.

7. Air An air conditioning system for a motor vehicle, the air conditioning system comprising a pressure sensor including:
a connector, a printed circuit, a metallic body and a pressure-sensitive element including a substrate including an internal face connected to the metallic body and an external face covered by a dielectric layer on which there are positioned four resistors arranged to form four electrical poles, each electrical pole being formed between two resistors and being connected to a conducting zone extending on the dielectric layer, each conducting zone being electrically connected to a connecting zone formed on the printed circuit by a connecting element;
wherein the external face of the substrate includes at least one earthing zone electrically connected to the printed circuit by a connecting means.

8. A method for the manufacture of a pressure sensor comprising a connector, a printed circuit, a metallic body and a pressure-sensitive element including a substrate, the method comprising:
depositing a dielectric layer on an external face of the substrate,
depositing a first metallic layer on the dielectric layer,
depositing a second metallic layer on the first metallic layer,
etching the first metallic layer to form four resistors on the dielectric layer, these resistors being arranged to form four electrical poles a conducting zone being formed on a portion of each electrical pole starting from the second metallic layer, and
connecting the conducting zone and a connecting zone formed on the printed circuit, using a connecting element wherein:
an operation of earthing the pressure-sensitive element, includes forming at least one earthing zone on the external face of the substrate and electrically connecting the earthing zone and the printed circuit using a connecting means.

9. The manufacturing method according to claim 8, wherein depositing the dielectric layer on the external face of the substrate, includes forming at least one spared portion on the external face of the substrate by masking off a portion from the dielectric layer.

10. The manufacturing method according to claim 8, wherein the external face of the substrate is completely covered by the dielectric layer when depositing the dielectric layer on the external face of the substrate, a laser-ablation operation then being applied to at least a portion of the dielectric layer in order to form at least one spared portion on the external face of the substrate.

11. The manufacturing method according to claim 9, wherein the spared portion forms the earthing zone the method comprising an electrical-connection step during which the connecting means connects the spared portion to a connecting zone formed on the printed circuit.

12. Manufacturing-The manufacturing method according to claim 9, wherein the first metallic layer covers the spared portion during the step of depositing the first metallic layer, the earthing zone being formed by a portion of the first metallic layer covering the spared portion and at the same time as the conducting zones.

13. The manufacturing method according to claim 9, wherein a portion of the first metallic layer covers the spared portion when depositing the first metallic layer, a second metallic layer being deposited on that portion of the first metallic layer that covers the spared portion so as to form a metallic conducting zone, the metallic conducting zone forming the earthing zone.
